(19) United States
(12) Patent Application Publication
(10) Pub. No.: US 2020/0393696 A1
(43) Pub. Date: Dec. 17, 2020

(54) 3D-PRINTED GLASSES STRUCTURES

(71) Applicant: Hwa Meei Optical Co., Ltd., Tainan (TW)

(72) Inventor: Chih Ming Chen, Tainan (TW)

(21) Appl. No.: 16/532,487

(22) Filed: Aug. 6, 2019

(30) Foreign Application Priority Data
Jun. 13, 2019 (TW) 108120461

(51) Int. Cl. G02C 5/00; G02C 5/14; G02C 5/08; G02C 5/12

(52) U.S. Cl. CPC G02C 5/008; G02C 5/14; B33Y 80/00; G02C 5/12; G02C 2200/16; G02C 5/08

(57) ABSTRACT

Provided is a 3D-printed glasses structure, including a frame, at least two threads and a stereoscopic mesh structure. The frame and at least two threads together define a spatial region, and the at least two threads are part of a contour of the frame. The stereoscopic mesh structure has a plurality of supporting strips and is disposed on the at least two threads. The plurality of supporting strips forms a stereoscopic mesh in an interleaving manner.

### BACKGROUND OF THE INVENTION

### 1. Field of the Invention

The present disclosure relates to a pair of glasses, and particularly relates to a pair of 3D-printed glasses.

### 2. The Prior Arts

With the development of modern society, glasses have become an indispensable item in today's life. However, glasses on the market are suitable for a glasses wearer's face by constantly trying to wear them. In addition, the glasses can only be improved in appearance and materials, thereby achieving the purpose of lightweight glasses.

Furthermore, since the automated 3D printing technology has matured, the 3D printing technology is currently being applied to medical and industrial fields. However, the application of customized eyewear products is still not widespread.

Moreover, today's eyewear products on the market still have the following problems: 1. the size of the frame or temple is not suitable, and 2. it feels uncomfortable after wearing. In addition, in the traditional mass production mode, the frame manufacturer often faces the cost pressure of large inventory. As far as traditional manufacturing is concerned, the more complex the shape of the object, the higher the manufacturing cost, and the large amount of waste products; for example, about 75% of the raw material (e.g., Cellulose acetate) of a plastic frame will eventually become waste.

Given the foregoing, how to provide a better eyeglasses structure that can be designed according to the glasses wearer's face shape, functional requirements and visual requirements, thereby increasing the glasses wearer's comfort, creating a personal style for the wearer, and overcoming the shortcomings of the above-mentioned waste products is one of the most important issues at present.

### SUMMARY OF THE INVENTION

In light of the foregoing problems, an objective of the present disclosure is to provide a 3D-printed glasses structure.

In an embodiment of the present disclosure, the present disclosure provides a 3D-printed glasses structure, including a frame, at least two threads, connected to the frame, wherein the frame and the at least two threads together define a spatial region, and the at least two threads are part of a contour of the frame; and a stereoscopic mesh structure, having a plurality of supporting strips and disposed on the at least two threads, wherein the plurality of supporting strips forms a stereoscopic mesh in an interleaving manner.

Preferably, the interleaving manner of the plurality of supporting strips is regular interleaving, irregular interleaving or a combination thereof.

Preferably, each of the plurality of supporting strips has a cross section of a ring, a square, a polygon or a combination thereof.

Preferably, the frame and the at least two threads are made of plastic, rubber, metal, alloy or a combination thereof.

Preferably, the frame is a full-rim glasses frame, a half-rim glasses frame or rimless.

In another embodiment of the present disclosure, the present disclosure also provides a 3D-printed glasses structure, including a temple; at least two threads, connected to the temple, wherein the temple and the at least two threads together define a spatial region, and the at least two threads are part of a contour of the temple; and a stereoscopic mesh structure, having a plurality of supporting strips and disposed on the at least two threads, wherein the plurality of supporting strips forms a stereoscopic mesh in an interleaving manner.

Preferably, the temple and the at least two threads are made of plastic, rubber, metal, alloy or a combination thereof.

In yet another embodiment of the present disclosure, the present disclosure further provides a 3D-printed glasses structure, including a frame, having at least two first threads that are connected to the frame and including a first stereoscopic mesh structure, wherein the frame and the at least two first threads together define a first spatial region, the at least two first threads are part of a contour of the frame, the first stereoscopic mesh structure has a plurality of first supporting strips and is disposed on the at least two first threads, and the plurality of first supporting strips forms a first stereoscopic mesh in an interleaving manner; and a temple, having at least two second threads that are connected to the temple and including a second stereoscopic mesh structure, wherein the temple and the at least two second threads together define a second spatial region, the at least two second threads are part of the contour of the frame, the second stereoscopic mesh structure has a plurality of second supporting strips and is disposed on the at least two second threads, and the plurality of second supporting strips forms a second stereoscopic mesh in the interleaving manner.

### BRIEF DESCRIPTION OF THE DRAWINGS

FIG. 1 is a three-dimensional schematic diagram of a 3D-printed glasses structure according to an embodiment of the present disclosure.

FIG. 2 is a top view of the 3D-printed glasses structure according to the embodiment of the present disclosure.

FIG. 3 is a cross-sectional diagram showing along the line A-A of FIG. 2 according to the embodiment of the present disclosure.

FIG. 4 is a side view of a 3D-printed glasses structure according to another embodiment of the present disclosure.

FIG. 5 is a partially three-dimensional schematic diagram of a stereoscopic mesh structure according to the present disclosure.

FIG. 6 is an enlarged cross-sectional diagram showing a stereoscopic mesh structure according to the present disclosure.

FIG. 7 is a three-dimensional diagram of a 3D-printed glasses structure according to yet another embodiment of the present disclosure.

### DETAILED DESCRIPTION OF THE PREFERRED EMBODIMENT

The detailed description of the present invention is provided in combination with the accompanying drawings.

The present disclosure provides a 3D-printed glasses structure, through a 3D printing technology. The 3D-printed glasses structure can be designed according to the wearer's face shape, functional requirements and visual requirements. Therefore, the mass/weight of the glasses can be effectively reduced so as to make the wearer more comfortable and lighter when wearing glasses, thereby creating a personal style for the wearer.

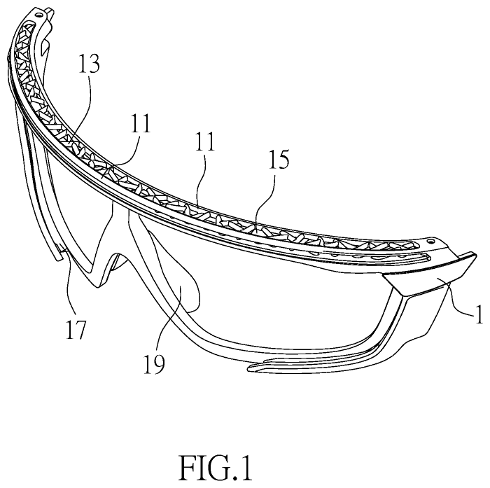

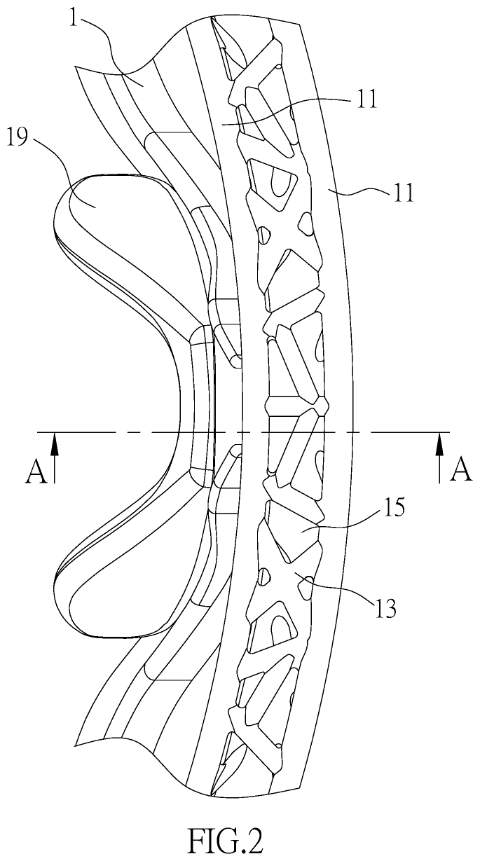

FIG. 1 shows a three-dimensional schematic diagram of a 3D-printed glasses structure according to an embodiment of the present disclosure. As shown in FIG. 1, the 3D-printed glasses structure includes a frame 1, at least two threads 11 and a stereoscopic mesh structure 13. The at least two threads 11 may be connected to the frame 1 in an interleaved or non-interlaced manner. FIGS. 1 and 2 of the present disclosure are represented in in a non-interlaced manner. The frame 1 and the at least two threads 11 together define a spatial region 15. The stereoscopic mesh structure 13 has a plurality of supporting strips and is disposed on the at least two threads 11. It is worth noting that FIG. 2 shows a top view of the 3D-printed glasses structure according to the embodiment of the present disclosure. As shown in FIG. 2, the plurality of supporting strips forms a stereoscopic mesh in an interleaving manner. Moreover, each of the plurality of supporting strips of the present disclosure has a cross section of a ring, a square, a polygon or a combination thereof, but does not limit the present disclosure.

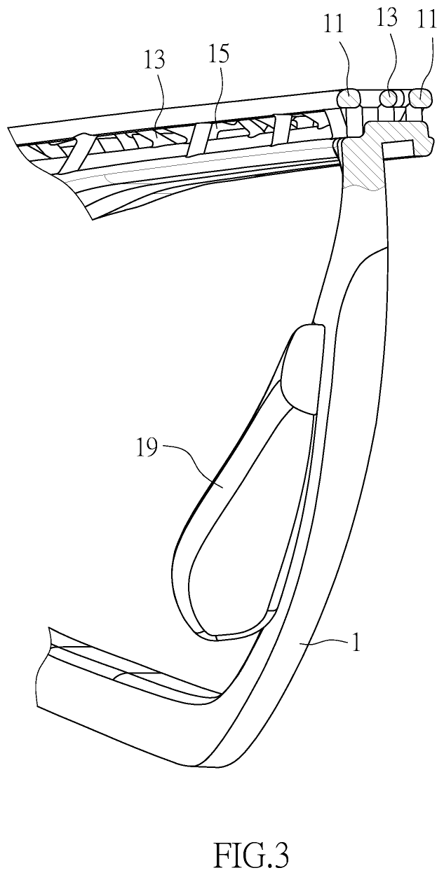

According to the embodiment of the present disclosure, as shown in FIGS. 1-3, the interleaving manner of the plurality of supporting strips is irregular interleaving. Each supporting strip is connected to the at least two threads 11, and can also be connected to a supporting strip between adjacent supporting strips to ensure the structural strength of the frame 1. The cross section of each supporting strips may be annular, square, polygonal or a combination thereof. The material of the frame 1 may be plastic, rubber, metal, alloy or a combination thereof, but does not limit the present disclosure. The spatial region 15 may be a non-closed space (as shown in FIGS. 1 and 2), but does not limit the present application. The frame 1 of the present application may be a full-rim glasses frame, a half-rim glasses frame or rimless.

Moreover, as shown in FIG. 1, the frame 1, the at least two threads 11 and the stereoscopic mesh structure 13 may be integrally formed by a 3D printing process.

According to the embodiment of the present application, as shown in FIGS. 1 and 2, the present disclosure further includes a lens (not shown), a slot 17 and a nose pad 19. The lens can be embedded in the slot 17. The slot 17 and the frame 1 may be integrally formed by a 3D printing process. The nose pad 19 and the frame may also be integrally formed by a 3D printing process.

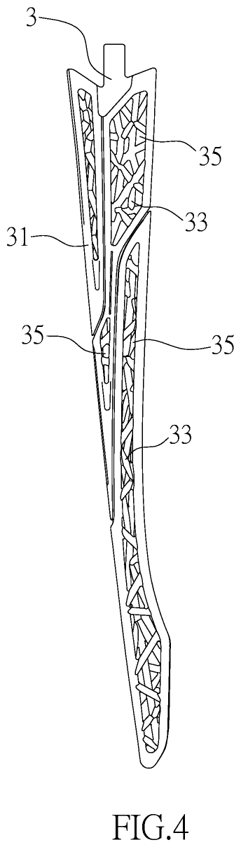

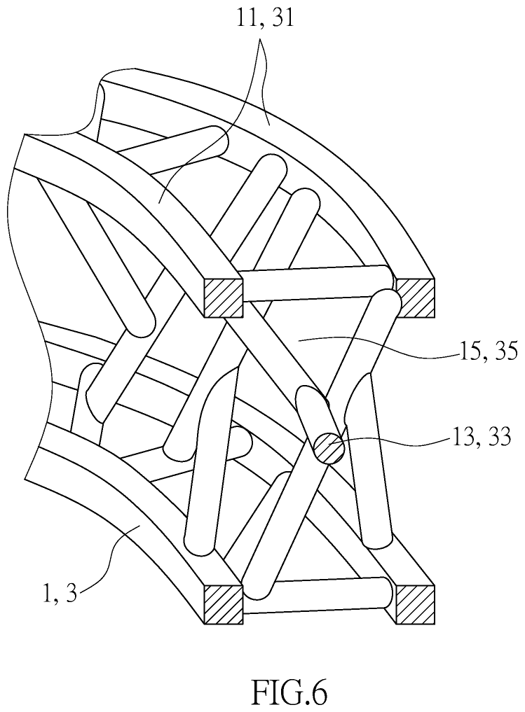

According to another embodiment of the present disclosure, as shown in FIG. 4, the 3D-printed glasses structure includes a temple 3, at least two threads 31 and a stereoscopic mesh structure 33. The at least two threads 31 may be connected to the temple 3 in an interleaved or non-interlaced manner. FIGS. 4 and 6 of the present disclosure are represented in a non-interlaced manner. The temple 3 and the at least two threads 11 together define a spatial region 35. The stereoscopic mesh structure 33 has a plurality of supporting strips and is disposed on the at least two threads 11. The plurality of supporting strips forms a stereoscopic mesh in an interleaving manner. Moreover, each of the plurality of supporting strips of the present disclosure has a cross section of a ring, a square, a polygon or a combination thereof, but does not limit the present disclosure.

According to another embodiment of the present disclosure, as shown in FIG. 4, the interleaving manner of the plurality of supporting strips is irregular interleaving, but does not limit the present disclosure. Each supporting strip is connected to the at least two threads 31, and can also be connected to a supporting strip between adjacent supporting strips to ensure the structural strength of the temple 3. The cross section of each supporting strips may be annular, square, polygonal or a combination thereof, but does not limit the present disclosure. Moreover, the material of the temple 3 may be plastic, rubber, metal, alloy or a combination thereof, but does not limit the present disclosure. The material of the stereoscopic mesh structure 33 may be plastic, rubber, metal, alloy or a combination thereof, but does not limit the present disclosure. The spatial region 15 may be a non-closed space (as shown in FIGS. 4 and 6), but does not limit the present application.

According to another embodiment of the present disclosure, as shown in FIG. 4, the temple 3, the at least two threads 31 and the stereoscopic mesh structure 33 may also be integrally formed by a 3D printing process.

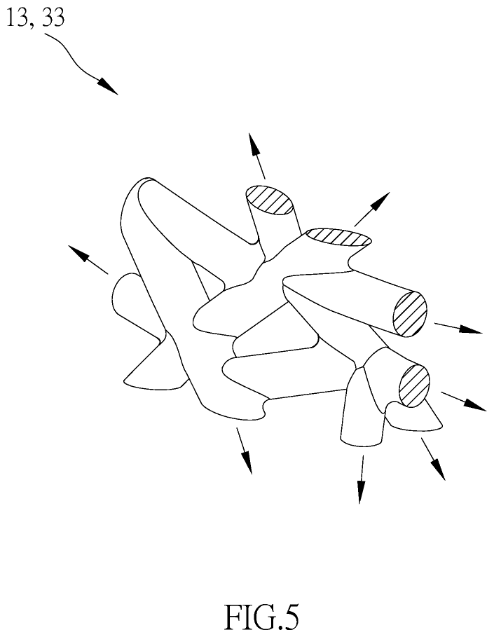

According to the aforementioned embodiments of the present disclosure, FIG. 5 shows a partially three-dimensional schematic diagram of a stereoscopic mesh structure. As shown in FIG. 5, the plurality of supporting strips forms a stereoscopic mesh in a regular interleaving manner or in an irregular interleaving manner, and can be connected to the surface in the spatial region, so that the weight of the present disclosure can be reduced while maintaining the structural strength of the glasses. As shown in FIG. 5, the arrows represent the directions in which the plurality of supporting strips extends.

According to the above embodiments of the present disclosure, FIG. 6 shows an enlarged cross-sectional diagram of a stereoscopic mesh structure. In the non-closed spatial region shown in FIG. 6, the stereoscopic mesh structures 13, 33 are formed directly on the threads in the spatial regions 15, 35.

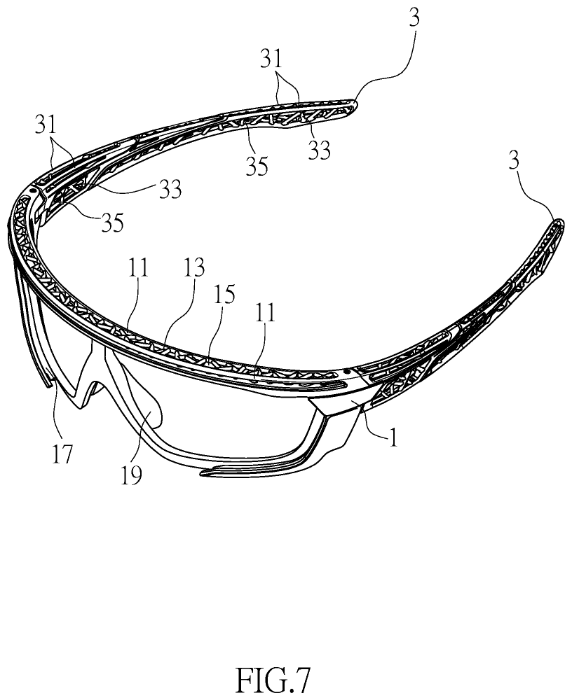

According to yet another embodiment of the present disclosure, as shown in FIG. 7, the 3D-printed glasses structure includes a frame 1, two temples 3 and a stereoscopic mesh structure 13, 33. The frame 1 has at least two threads 11 that are connected to the frame 1. The at least two threads 11 and the frame 1 together define a first spatial region 15. The at least two threads 11 may be connected to the frame 1 in a non-interlaced or interlaced manner. The stereoscopic mesh structure 13 is disposed in the first spatial region 15.

According to yet another embodiment of the present disclosure, the temple 3 has at least two threads 31 that are connected to the temple 3 in an interleaving or non-interlaced manner, and the at least two threads 31 and the temple together define a second spatial region 35. Moreover, a stereoscopic mesh structure 33 is disposed in the second spatial region 35.

According to yet another embodiment of the present disclosure, each stereoscopic mesh structure 13, 33 has a plurality of supporting strips and is disposed on the at least two threads 11, 31. It is worth noting that the plurality of supporting strips forms a stereoscopic mesh in an interleaving manner inside the first spatial region 15 and the second spatial region 35. In addition, the frame 1, the two temples 3, the at least two threads 11, 31 and the stereoscopic mesh structures 13, 33 can be integrally formed by a 3D printing process. Besides, the frame 1 is also provided with a slot 17 for mounting and embedding the lens (not shown) in the slot 17. According to the present disclosure, the lens and the frame 1 can also be integrally formed by a 3D printing process.

Please note that the above embodiments of the present disclosure can produce a pair of 3D-printed glasses by a 3D printing apparatus, instruments or equipment, but do not limit the present disclosure.

In summary, the present disclosure is able to scan the wearer's facial features through three-dimensional scanning, automated design techniques, and three-dimensional printing technology, providing the wearer customized and personalized glasses services, and reducing the waste generated when the glasses are manufactured. According to the present disclosure, the mass/weight of the glasses can be effectively reduced, thereby making the wearer more comfortable and light when wearing glasses.

Although the present disclosure has been described with reference to the preferred exemplary embodiments thereof, it is apparent to those skilled in the art that a variety of modifications and changes may be made without departing from the scope of the present disclosure which is intended to be defined by the appended claims.

What is claimed is:

1. A 3D-printed glasses structure, comprising:
a frame;
at least two threads, connected to the frame, wherein the frame and the at least two threads together define a spatial region, and the at least two threads are part of a contour of the frame; and
a stereoscopic mesh structure, having a plurality of supporting strips and disposed on the at least two threads, wherein the plurality of supporting strips forms a stereoscopic mesh in an interleaving manner.

2. The 3D-printed glasses structure of claim 1, wherein the interleaving manner of the plurality of supporting strips is regular interleaving, irregular interleaving or a combination thereof.

3. The 3D-printed glasses structure of claim 1, wherein each of the plurality of supporting strips has a cross section of a ring, a square, a polygon or a combination thereof.

4. The 3D-printed glasses structure of claim 1, wherein the frame and the at least two threads are made of plastic, rubber, metal, alloy or a combination thereof.

5. The 3D-printed glasses structure of claim 1, wherein the frame is a full-rim glasses frame, a half-rim glasses frame or rimless.

6. A 3D-printed glasses structure, comprising:
a temple;
at least two threads, connected to the temple, wherein the temple and the at least two threads together define a spatial region, and the at least two threads are part of a contour of the temple; and
a stereoscopic mesh structure, having a plurality of supporting strips and disposed on the at least two threads, wherein the plurality of supporting strips forms a stereoscopic mesh in an interleaving manner.

7. The 3D-printed glasses structure of claim 6, wherein the interleaving manner of the plurality of supporting strips is regular interleaving, irregular interleaving or a combination thereof.

8. The 3D-printed glasses structure of claim 6, wherein each of the plurality of supporting strips has a cross section of a ring, a square, a polygon or a combination thereof.

9. The 3D-printed glasses structure of claim 6, wherein the temple and the at least two threads are made of plastic, rubber, metal, alloy or a combination thereof.

10. A 3D-printed glasses structure, comprising:
a frame, having at least two first threads that are connected to the frame and including a first stereoscopic mesh structure, wherein the frame and the at least two first threads together define a first spatial region, the at least two first threads are part of a contour of the frame, the first stereoscopic mesh structure has a plurality of first supporting strips and is disposed on the at least two first threads, and the plurality of first supporting strips forms a first stereoscopic mesh in an interleaving manner; and
a temple, having at least two second threads that are connected to the temple and including a second stereoscopic mesh structure, wherein the temple and the at least two second threads together define a second spatial region, the at least two second threads are part of the contour of the frame, the second stereoscopic mesh structure has a plurality of second supporting strips and is disposed on the at least two second threads, and the plurality of second supporting strips forms a second stereoscopic mesh in the interleaving manner.
